(19) United States
(12) Patent Application Publication
(10) Pub. No.: US 2011/0303718 A1
(43) Pub. Date: Dec. 15, 2011

(54) HAND-HELD DRIVING TOOL

(75) Inventors: Robert SPASOV, Schaan (LI); Ulrich Schiestl, Hohenems (AT); Harald Fielitz, Lindau (DE); Karl Franz, Feldkirch (AT); Klaus Bertsch, Feldkirch (AT)

(73) Assignee: Hilti Aktiengesellschaft, Schaan (LI)

(21) Appl. No.: 13/160,241

(22) Filed: Jun. 14, 2011

(30) Foreign Application Priority Data
Jun. 15, 2010 (DE) 10 2010 030 059.4

(51) Int. Cl. B25C 5/15; B25F 5/00

(52) U.S. Cl. 227/2; 165/287

(57) ABSTRACT

A hand-held driving tool and a method for cooling the driving tool is disclosed. The driving tool includes a driving ram, a mechanical energy storage mechanism, and an electric motor for introducing mechanical energy into the energy storage mechanism. A cooling system is provided for cooling the electric motor, in particular as a function of a motor status.

This application claims the priority of German Patent Document No. 10 2010 030 059.4, filed Jun. 15, 2010, the disclosure of which is expressly incorporated by reference herein.

### BACKGROUND AND SUMMARY OF THE INVENTION

The invention relates to a hand-held driving tool.

German Patent Document No. DE 10 2006 000 517 A1 describes a hand-held driving tool with which a spiral spring can be stressed by means of an electric motor via a ball screw. After releasing the spiral spring under tension, it acts on a driving ram by means of which fastening elements from a magazine of the driving tool can be driven into a workpiece.

The object of the present invention is to provide a hand-held driving tool having an improved efficiency.

In accordance with the principles of the present invention, damage to the motor due to overheating is prevented by providing a cooling system for cooling the electric motor, depending on the status of the motor. In this way, the motor can be designed with a higher power or designed to be smaller at any power. Depending on requirements, continuous operation may also be required or the frequency of the driving tool may be increased.

A mechanical energy storage mechanism in the sense of this invention is any suitable measure to store the mechanical energy supplied by the electric motor over a period of time in an integrated fashion, to deliver this energy for the purpose of the driving operation, in particular in a shorter period of time and/or at a higher power. Examples of this include springs made of metal or carbon fiber, gas pressure storage mechanisms, flywheels and the like.

Previous approaches to the design of driving tools have not taken into account motor cooling because the motors are usually activated only temporarily to charge the energy storage mechanism. With demands for corresponding motor power or an especially small installation space for the motors, however, it has been found that the given dissipation of heat from the motor may be inadequate.

In a preferred embodiment of a driving tool, it is provided that the cooling system generates an air stream to flow at least over the electric motor. The cooling air may enter and leave the housing through suitably positioned slots.

In an advantageous refinement, the cooling system comprises a fan having a drive separately from the electric motor. Thus a cooling air stream can be ensured in general and in adequate quantity in particular when the motor is operated only in short intervals or with a constant change in the direction of rotation. The fan may preferably be switchable via an electronic controller as a function of the motor status. The motor status which supplies the switching criterion may preferably but not necessarily be the temperature of the electric motor.

To optimize the installation space, it is possible to provide for the fan to be set up in the area of a handle on the driving tool.

For example, if parts of the tool are protected from the admission of dirt from the outside, and the motor is therefore accommodated in a separate housing part, which is separate from the area protected from dirt, it may also be provided that the fan is arranged in the area of the motor.

If the electronic system includes components which become especially hot during ongoing operation, it is also possible to provide for the fan to be set up in the area of the electronic system. If necessary, two or more separate fans may also be provided, one of which is arranged in the area of the motor and the other being arranged in the area of the electronic system, for example.

It is especially preferable for optimizing the cooling system for the fan to be activated at least temporarily when the electric motor is not activated. In particular the fan may therefore be designed to be especially small.

In general, the air stream may advantageously be in a thermal exchange with at least one other component of the driving tool to also cool this component as needed. This component may preferably but need not necessarily be an electrical storage mechanism, for example, a replaceable battery insert and/or an electronic power unit.

In an alternative embodiment of the invention, the air stream may also be generated by a movable mechanical system of the driving tool. This is preferably but not necessarily the drive arrangement and/or the driving ram. Such a measure to generate an air stream may be provided as a single measure as well as in combination with any other measure according to the present invention. As a possible detail design, the driving ram may be guided in suitable proximity to an air channel, for example, so that the air stream necessarily generated after triggering the driving ram may be guided to the motor, which is usually deactivated at this time.

In another alternative or supplementary embodiment, it is provided that the cooling system comprises deactivation of the electric motor as a function of the motor status.

The electric motor may remain deactivated until the motor has had enough time to cool depending on demands. However, there may also be a targeted lengthening of the possible frequency, so that a user of the driving tool is not interrupted in his/her activity but instead is simply slowed down. With a suitable dosing of deactivated times of the motor, this slowing may occur unnoticeably or at least may not be perceived as annoying.

In one possible embodiment of the invention, the motor status is determined by a suitably placed temperature sensor. The temperature sensor may be arranged directly on the motor or on a component of an electronic controller, depending on the requirements, directly on the inside or outside of the electric motor. This takes into account the fact that the heating of at least certain parts of an electronic controller is strongly correlated with heating of the electric motor. This may also involve temperature measurement of specially provided components such as a calibrated resistor.

Alternatively or in addition to a direct measurement of a temperature, the motor status may also be determined by calculating the operating variables. These may preferably be the motor current and motor voltage.

The motor status may advantageously be calculated in general by predictive calculation from operating data and/or by counting load cycles and/or by a resistance measurement of a motor winding. The use of any known parameter or a parameter measured in a targeted manner is essentially conceivable as long as it has an adequate correlation with the motor status, in particular the motor temperature.

It is preferably provided in general that at least parts of the cooling system are supported via a damping element in a decoupled manner. This takes into account the high mechanical loads in the housing of a driving tool. For example, a fan which might be provided may be accommodated in rubber bearings, so that the rubber bearings form the damping element.

In general, it is preferably provided that a fan wheel arranged on a motor shaft of the electric motor is not provided. Such fan wheels are widely used for cooling purposes in electric motors that are operated continuously. However, it has been found that these fan wheels are not very effective with driving tools because the motors run only briefly under a high load and also change their direction of rotation, depending on the design of the driving tool. By providing a cooling system according to the invention, it is possible to omit such a fan wheel. In particular the installation space required for the motor can be kept small in this way.

Additional advantages and features of the invention are derived from the exemplary embodiments described below.

Two preferred exemplary embodiments of the invention are described below and are explained in greater detail with reference to the accompanying drawings.

### BRIEF DESCRIPTION OF THE DRAWINGS

FIG. 1 shows a schematic sectional view of a first exemplary embodiment of the invention.

FIG. 2 shows a schematic sectional view of a second exemplary embodiment of the invention.

FIG. 3 shows a schematic sectional view of a third exemplary embodiment of the invention.

### DETAILED DESCRIPTION OF THE DRAWINGS

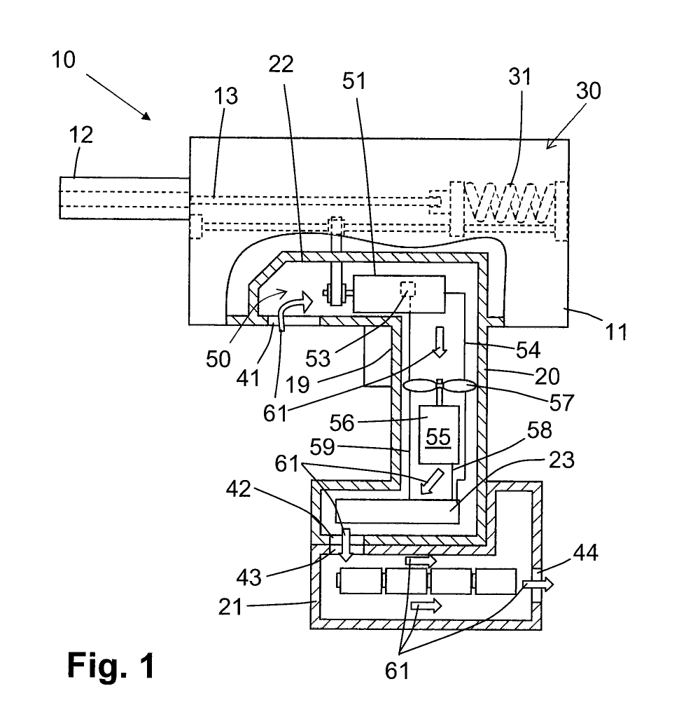

The hand-held driving tool 10 illustrated in FIG. 1 is operated electrically and has a housing 11 and a drive arrangement arranged therein, labeled as 30 on the whole, for a driving ram 13, which is guided to be linearly displaceable in a guide.

A mechanical energy storage mechanism is designed as a spring 31 that can be stressed, and in the present case a helical spring made of metal.

The mechanical energy storage mechanism, i.e., the spring 31, may be stressed via the drive arrangement 30, for which purpose it includes a tension mechanism 50 with an electric motor 51. In addition to the electric motor, the drive arrangement includes other mechanical elements, for example, a rotary spindle with a recirculating ball nut.

The driving tool 10 has a handle 20 on which there is a trigger switch 19 for triggering a driving operation using the driving tool 10. Triggering is done electromechanically, so that control of the device state by an electronic control unit is possible in a simple manner before releasing the mechanical energy storage mechanism.

Adjacent to the handle 20, a power supply labeled as 21 on the whole is arranged, by which the driving tool 10 is supplied with electricity. In the present case the power supply 21 is designed as a battery which is replaceably attachable to a lower end of the handle and includes a plurality of battery cells.

An electrical control unit 23 is provided in the lower area of the handle and serves to control the electric motor for putting the spring 31 under tension as well as for the secured release of the mechanical energy storage mechanism 31 thereby charged up after actuation of the trigger switch 19.

The trigger switch 19 is therefore connected to the control unit 23 via a switch line. The electric motor 51 is connected to the control unit 23 via a control line 54 and may be put in operation by it, for example, when a press switch (not shown) on a mouth part 12 is operated in a pressing operation or, after the driving operation is completed, when the driving tool 10 is lifted up from a workpiece again.

A cooling system for cooling the electric motor 51 is arranged in the handle 20 of the driving tool 10. It comprises an electrically driven fan 55 which comprises a fan motor 56 and a fan rotor 57. The fan motor 56 is connected by a line 58 to the control unit 23 and may be activated by it.

A temperature sensor 53 for monitoring the temperature of the electric motor 51 is provided in the electric motor 51 of the drive arrangement 30. The temperature sensor 53 is connected by a line 59 to the control unit 23 which activates and deactivates the motor 56 of the fan 55 as a function of the temperature Tm of the electric motor 51 and as a function of limit values for the temperature of the electric motor 51 stored in a memory of the control unit 23.

The fan motor 56 may also be activated when the electric motor 51 is not running briefly (for example during triggering of the energy storage mechanism 31) or even for a longer period of time (for example because the trigger switch 19 is not operated for a period of time). A hysteresis for the desired temperature profile of the electric motor is expediently defined so that after activation of the fan 55 because a limit temperature Tmax has been exceeded, the motor is cooled until the temperature Tm of the motor is below a lower temperature Tmin. Then the motor may heat up during operation by a temperature Tmax−Tmin without having to activate the fan 55 again.

The fan 55 produces a stream of air along the arrow 61, thereby not only cooling the fan motor 56 but then also the electronic controller 23 and the power supply 21. To do so, the air in an upper front housing area 50 is drawn in through fan slots 41. An inner housing wall 22 divides the intake area from the housing area of the remaining drive configuration 30, so that an air channel is formed in which the electric motor 51 is arranged. In this way, the intake air is guided primarily first to the electric motor 51. After the air passes over or through the electric motor 51, it is deflected downward by 90° by the housing wall 22, after which the air flows from top to bottom through the interior of the handle 20 and passes by the fan 56, 57 which has been operating on intake up to that point in time.

Downstream from the fan 56, 57, the air enters a lower enlargement, where the electronic controller 23 is accommodated. In the lower closure of the handle 20 and in an upper cover for the power supply 21 mounted beneath the handle, overlapping passages 42, 43 are provided through which the cooling air flows from the handle 20 into the power supply 21. After passing over the battery cells, the cooling air then flows back into the exterior space through an opening 44 in the housing of the power supply.

Thus on the whole first the electric motor 51 then the electronic controller 23 and at last the power supply 21 are cooled.

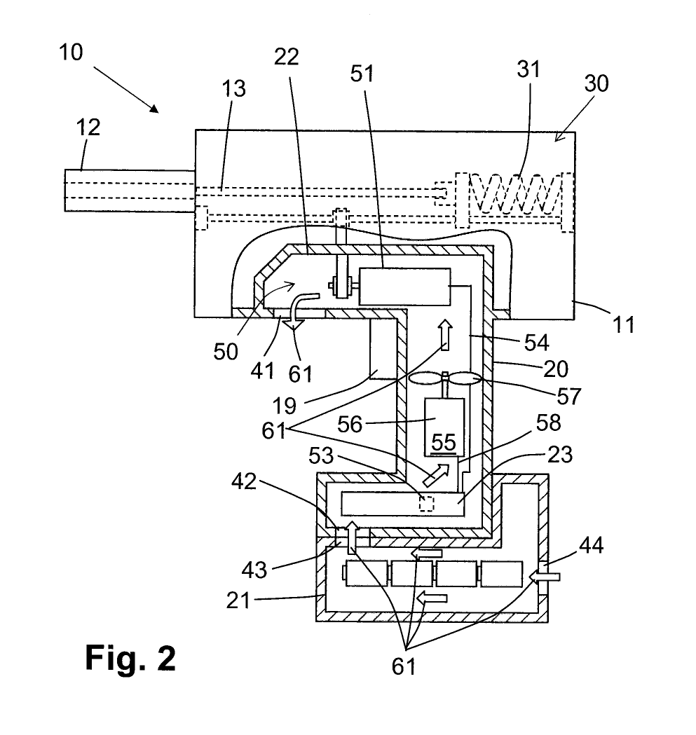

In the second exemplary embodiment of the invention shown in FIG. 2, the fan 56, 57 is operated in the reverse direction so the air stream follows exactly the opposite path but the housing is otherwise designed the same. Accordingly, the power supply 21 is cooled first here, then the electronic controller 23 and finally the electric motor 51. In this reverse order the air temperature for cooling the electric motor 51 is higher but the power supply is cooled better. This may be desirable in particular with thermally sensitive and high-grade batteries such as lithium-ion batteries.

Another difference in comparison with the first exemplary embodiment consists of the arrangement of the temperature measurement. In the example according to FIG. 2 the temperature sensor 53 is arranged in the area of the electronic controller. In addition, this may be advantageous if the electronic controller is especially sensitive to temperature in comparison with the motor. In addition, however, a motor temperature may regularly be inferred from a temperature of the electronic controller because the thermal power loss is linked monotonically at least, but often not in a mostly linear fashion.

The precise arrangement of the temperature sensor 53 on the electronic controller 23 may be adjusted to requirements. For example, it may be mounted on a power component through which essentially the same current flows as the electric motor 51. It may even be a component which is built into the electronic system only for this purpose, e.g., a calibrated resistor. The advantage of these variants is that no sensor need be installed in the motor itself, which makes the motor simpler and less expensive.

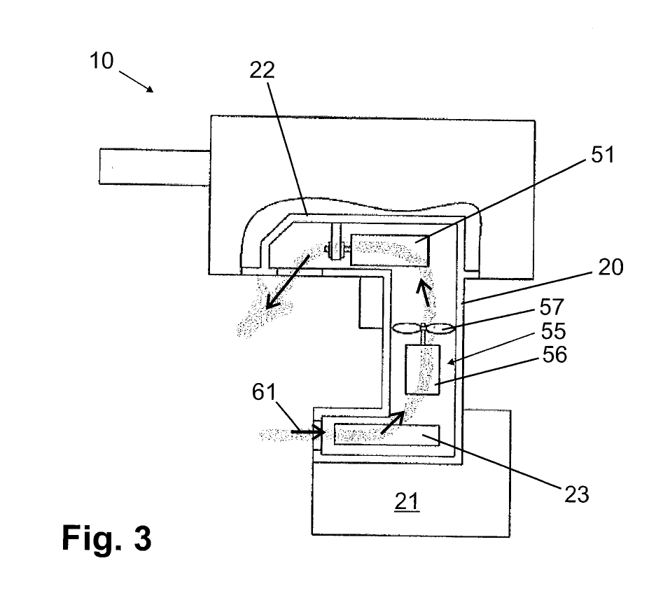

In the third exemplary embodiment shown in FIG. 3 the cooling air is not passed through the power supply but instead first passes over the electronic controller 23 and last of all the electric motor 51.

In addition to a direct measurement of temperature by a temperature sensor 53, a motor status which is relevant for the cooling system may additionally or alternatively be detected by other measures. For example, a number of load cycles of the electric motor 51 may be counted and this information may be used to infer the motor temperature, optionally taking into account the operating time. Such a temperature calculation method could be performed by measuring the temperature in the tool or the surroundings or the electronic system because the surroundings can be imaged in this way.

In addition, the heating of the motor may be inferred on the basis of the motor current or the motor power. Another possibility for determining the temperature is offered by a resistance measurement of a winding of the motor.

In another exemplary embodiment of the invention, the motor is cooled by deactivating it after reaching a corresponding motor status. Such a cooling system by deactivation of the motor may be provided as an alternative or in addition to a cooling fan 56, 57.

It is evident that the individual features of the exemplary embodiments described above may be combined with one another in any way depending on requirements.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand-held driving tool, comprising:
a driving ram;
an energy storage mechanism coupled to the driving ram;
an electric motor coupled to the energy storage mechanism; and
a cooling system, wherein the electric motor is coolable by the cooling system as a function of a motor status.

2. The driving tool according to claim 1, wherein an air stream is generatable and supplyable to the electric motor by the cooling system.

3. The driving tool according to claim 1, wherein the cooling system includes a fan with a drive that is separate from the electric motor.

4. The driving tool according to claim 3, wherein the fan is switchable via an electronic controller as a function of the motor status.

5. The driving tool according to claim 4, wherein the motor status is a temperature of the electric motor.

6. The driving tool according to claim 3, wherein the fan is arranged in an area of a handle of the driving tool or in an area of the electric motor or in an area of an electronic controller.

7. The driving tool according to claim 3, wherein the fan is activatable at least temporarily when the electric motor is not activated.

8. The driving tool according to claim 2, wherein the air stream is supplyable to an electric energy storage mechanism and/or an electronic power unit.

9. The driving tool according to claim 1, wherein the electric motor is coolable by a deactivation of the electric motor as a function of the motor status.

10. The driving tool according to claim 1, wherein the motor status is determinable by a temperature sensor.

11. The driving tool according to claim 10, wherein the temperature sensor is arranged on the electric motor or on a component of an electronic controller.

12. The driving tool according to claim 1, wherein the motor status is determinable by calculation from a motor current and/or a motor voltage.

13. The driving tool according to claim 1, wherein the motor status is determinable by predictive calculation from operating data, by counting load cycles and/or by resistance measurement of a motor coil.

14. The driving tool according to claim 1, wherein at least a part of the cooling system is stored such that it is impact-decoupled via a damping element.

15. The driving tool according to claim 1, wherein a fan wheel arranged on a motor shaft of the electric motor is not provided.

16. A method for cooling a driving tool, comprising the steps of:
cooling an electric motor of the driving tool by a cooling system as a function of a motor status;
wherein the electric motor is coupled to an energy storage mechanism and wherein the energy storage mechanism is coupled to a driving ram.

17. The method according to claim 16, wherein the step of cooling includes generating and supplying an air stream to the electric motor by the cooling system.

18. The method according to claim 16, further comprising the step of cooling the electric motor by deactivating the electric motor as a function of the motor status.

19. The method according to claim 16, further comprising the step of determining the motor status by a temperature sensor.

20. The method according to claim 16, further comprising the step of activating the fan at least temporarily when the electric motor is not activated.
